(19) United States
(12) Patent Application Publication
(10) Pub. No.: US 2009/0143940 A1
(43) Pub. Date: Jun. 4, 2009

(54) Steering control for a vehicle

(76) Inventors: James Rhodes, Las Vegas, NV (US); Kevin T. Parent, Santa Barbara, CA (US); Frank K. Weigand, La Canada, CA (US); Greg Rude, Manhattan Beach, CA (US)

Correspondence Address: K&L Gates LLP, P.O. BOX 1135, CHICAGO, IL, 60690, US

(21) Appl. No.: 11/947,878

(22) Filed: Nov. 30, 2007

(51) Int. Cl. G05D 3/10

(52) U.S. Cl. 701/41

(57) ABSTRACT

A control system for steering at least one vehicle including a first plurality of sensors operably coupled to a respective wheel of the vehicle, a second plurality of sensors operably coupled to a respective input device, and a vehicle controller. The vehicle controller is operably coupled to the sensors and each respective wheel for controlling the velocity of each wheel to achieve a desired speed and direction based on the data signals received from the sensors. The vehicle controller controls the velocity of each wheel independently to achieve the desired speed and direction of the vehicle.

### CROSS-REFERENCE TO RELATED APPLICATIONS

This application is related to co-pending U.S. patent application Ser. No. 11/431,196 entitled “BUILDING TRANSPORT DEVICE” and filed on May 9, 2006; U.S. patent application Ser. No. 11/620,103 entitled “DEVICE AND METHOD FOR TRANSPORTING A LOAD” and filed on Jan. 5, 2007; U.S. patent application Ser. No. 11/559,229 entitled “TRANSPORT DEVICE CAPABLE OF ADJUSTMENT TO MAINTAIN LOAD PLANARITY” and filed on Nov. 13, 2006; U.S. patent application Ser. No. 11/620,560 entitled “METHOD AND APPARATUS FOR MOBILE STEM WALL” and filed on Jan. 5, 2007; and U.S. Provisional Patent Application Ser. No. 60/887,696, entitled “METHOD AND APPARATUS FOR INTEGRATED INVENTORY AND PLANNING” and filed on Feb. 1, 2007. The entire contents of each application noted above are hereby fully incorporated by reference.

### COPYRIGHT NOTICE

A portion of the disclosure of this patent document contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Steering systems implemented in most vehicles are purely mechanical; particularly in the case of vehicles used for transporting large loads such as flat bed trucks and the like. Most of these mechanical systems have considerable limitations with regard to the turning radius that can be achieved. Although all-wheel steering systems provide an improvement in turning radius of large vehicles, these systems often require the use of more than one operator. For example, one operator controlling steering in the front of the vehicle and another operator controlling steering in the rear of the vehicle. Additionally, these mechanical systems add considerable weight to the vehicle and require significant maintenance.

### SUMMARY

In one embodiment, the control system for steering at least one vehicle includes an input device for inputting a desired direction and speed of the vehicle. The system also includes a plurality of first sensors coupled to each wheel of the vehicle for sensing a velocity of the wheel; a plurality of second sensors proximate to each wheel for sensing a direction of the wheel; and a plurality of motors controlled by respective motor controllers operably coupled to each wheel. A vehicle controller operably coupled to the first and second sensors, and the motor controllers control the velocity of each wheel to achieve a desired speed and direction of the vehicle.

In one embodiment, the vehicle controller includes a memory device, and a plurality of instructions or algorithms stored on the memory device. The instructions when executed by at least one processor cause the vehicle controller to: determine a desired speed and direction of the vehicle based on the inputs from the input device; determine the actual speed and direction of the vehicle based on feedback signals from the sensors; compare the desired speed and direction of the vehicle with the actual speed and direction; and determine a corrected speed and direction of the vehicle. The vehicle controller uses corrected values for the speed and direction to independently control the velocity of each wheel to achieve a desired speed and direction.

Other features and advantages of the invention will be apparent from the following detailed disclosure, taken in conjunction with the accompanying sheets of drawings, wherein like numerals refer to like parts, elements, components, steps and processes.

### BRIEF DESCRIPTION OF THE FIGURES

FIG. 1 illustrates one embodiment of a vehicle in which a steering control system is implemented.

FIG. 2 is a top perspective view of one end of the vehicle of FIG. 1 illustrating the linkage and pivots between the bogie and the chassis.

FIG. 3 is a cross-sectional view of the bogie for the vehicle illustrated in FIG. 1.

FIG. 4 is one embodiment of a vehicle control system for steering a vehicle.

FIG. 5 is a more detailed illustration of the vehicle control system for steering the vehicle illustrated in FIG. 4.

FIG. 6 is a flowchart illustrating a method for steering a vehicle according to one embodiment.

FIG. 7 is a perspective view illustrating one embodiment of two vehicles connected together.

FIG. 8 is a block diagram illustrating one embodiment for connecting vehicle control systems of two different vehicles.

FIG. 9 is a flow diagram illustrating one embodiment for implementing steering control for two connected vehicles.

FIGS. 10 & 11 illustrate one embodiment for determining the instantaneous center for two connected vehicles.

FIG. 12 illustrates one embodiment for transporting a load using two connected vehicles.

FIG. 13 illustrates one embodiment of a graphical user interface implemented in the vehicle control system.

### DETAILED DESCRIPTION

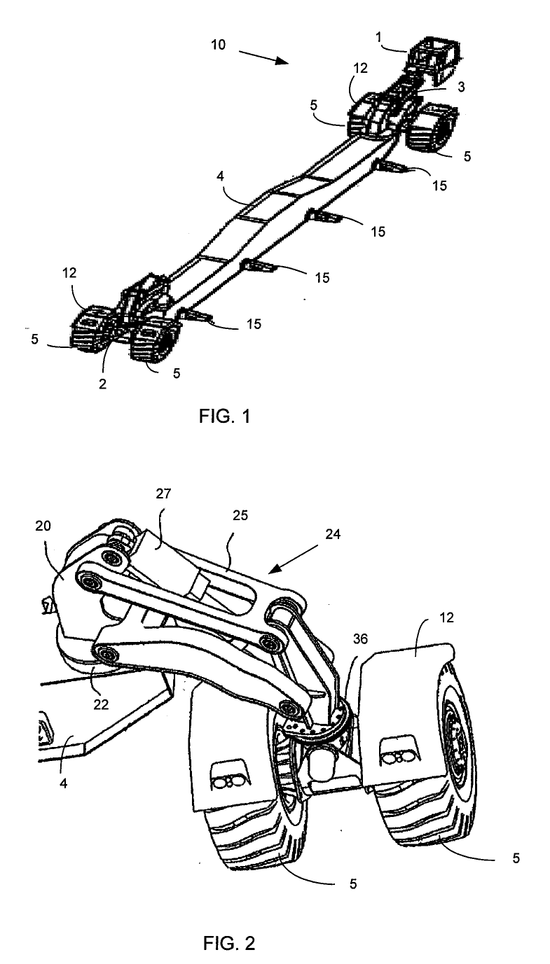

Referring to FIG. 1, in one embodiment, a vehicle 10 in which a vehicle control system can be implemented is illustrated. The vehicle includes at least one independent support structure or chassis 4. Preferably, the vehicle 10 can be coupled together with one or more vehicles 10 using any suitable means such that the vehicles 10 can be configured to transport a large load (e.g., a house or building). For example, the protrusions 15 along with corresponding support beams (not shown) can be used for connecting to another vehicle 10. When utilizing more than one vehicle 10, each vehicle 10 can be substantially similar or can be designed in any suitable manner such that each vehicle 10 can operate alone or in combination with another vehicle 10.

As shown in FIG. 1, the chassis 4 has a front end 2 and a rear end 3. Each of the vehicles 10 is coupled to a respective bogie 12, and each bogie 12 includes two wheels 5. The chassis 4 can be coupled to the bogies 12 in any suitable manner, such as with a stub axle or being hingedly coupled to a yoke or connecting arm (not shown). One end of the vehicle 10 has a driver's cab 1 situated over the bogie 12 and is configured to rotate in any suitable manner. For example, each cab 1 can rotate up to and including 180 degrees (or any other suitable amount) or, alternatively, the driver and his seat can rotate relative to the cab 1. Preferably, the driver's cab 1 is situated to be a high visibility, air conditioned station that allows the driver to control the vehicle 10; however, the driver's cab 1 can be any suitable steering platform and can be positioned in any suitable area of the vehicle 10.

By way of example, inside the cab 1, the operator has familiar drive and steering devices such as a steering wheel, an accelerator pedal and a brake pedal. Additionally, the operator can also have a joystick for controlling the vehicle at low speeds (e.g., 2 MPH or less). The following is an exemplary list of control features available to the operator in the cab 1.

Operator Controls

Motion Stop

Engine On/Off Key Switch

Hydraulic System Power Bus Key Switch

Auto/Manual Mode Selector

Deadman/Enable Pushbutton

Man Machine Interface Panel

Joystick

Steering Wheel

Brake Pedal

Accelerator Pedal

Additionally, it is not necessary for each vehicle 10 to have a driver's cab 1 or steering ability. Additionally, only one of the vehicles 10 can be equipped with such capabilities. Additionally, the vehicle 10 can be remote controlled, controlled via artificial intelligence or computer, run on a track, or follow a preprogrammed course or by any other suitable means. Fine control or positioning of each vehicle 10 preferably occurs under the control of an operator in the cab 1 and/or at a remote controller that can be positioned in any suitable manner, such as outside of the cab 1 or remote from the cab 1.

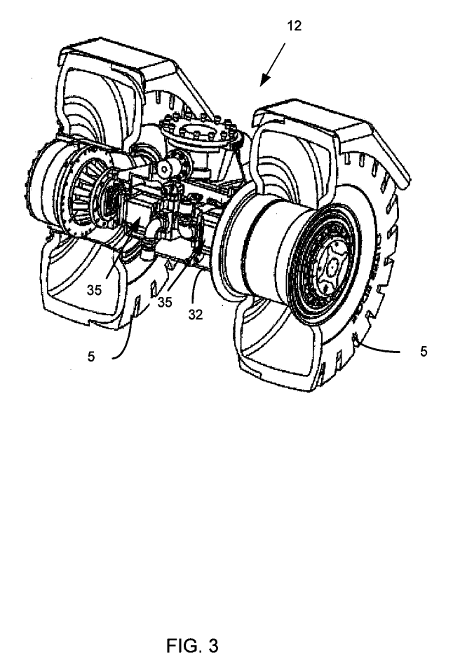

As shown in FIG. 2, a four-bar parallelogram linkage 24 couples the protrusion 20 on one end to the chassis 4 and couples the rotation pivot 36 to the bogie 12 on the other end. The combination of linkage 24 and the ring bearings 22 allows for adjustment of a load carried by the vehicle. Linkage 24 also includes a U-shaped linkage 25. The linkage 24 is driven by a dedicated hydraulic actuator 27, such that as the actuator extends, the bogie 12 lowers relative to the chassis 4. The actuator 27 may be either a conventional hydraulic servoactuator, or a counterbalance cylinder concentric and working in parallel with a smaller servoactuator or an electromechanical actuator or any other similar means of actuation.

The actuator 27 preferably has a dynamic lifting capacity of at least 200,000 pounds with a 10-inch bore and a 38-inch stroke, but can have any suitable lifting capacity. The travel of the bogie 12 in the vertical direction is preferably about six feet, but can be any suitable distance. In particular, the conventional servoactuators can be hydraulic actuators with integral position feedback and pressure transducers for load feedback that lift and support the payload.

In another embodiment, counterbalanced actuators can be utilized, which are smaller hydraulic actuators connected to a constant pressure source to lift and support a significant portion of the payload weight. That is, the large conventional servo actuators could be replaced by a smaller counterbalance actuator with a smaller servo actuator mechanically connected in parallel. The counterbalance actuator will support most of the payload's dead weight with the smaller servo actuator only required to actively position the payload

In another embodiment, the chassis 4 can be hingedly coupled to the bogie 12 via a yoke (not shown). Each yoke can be independently adjusted using two hydraulic pistons or actuators. Preferably, each yoke is coupled to the chassis 4 using a rotational pivot and a hinge (not shown), but may be coupled to the chassis 4 in any suitable manner. Preferably, the pivot allows the yoke to swing through an arc that is substantially parallel to the ground. The yoke extends to a respective bogie 12 and connects to one end of an actuator. The yoke is coupled to one end of the actuator.

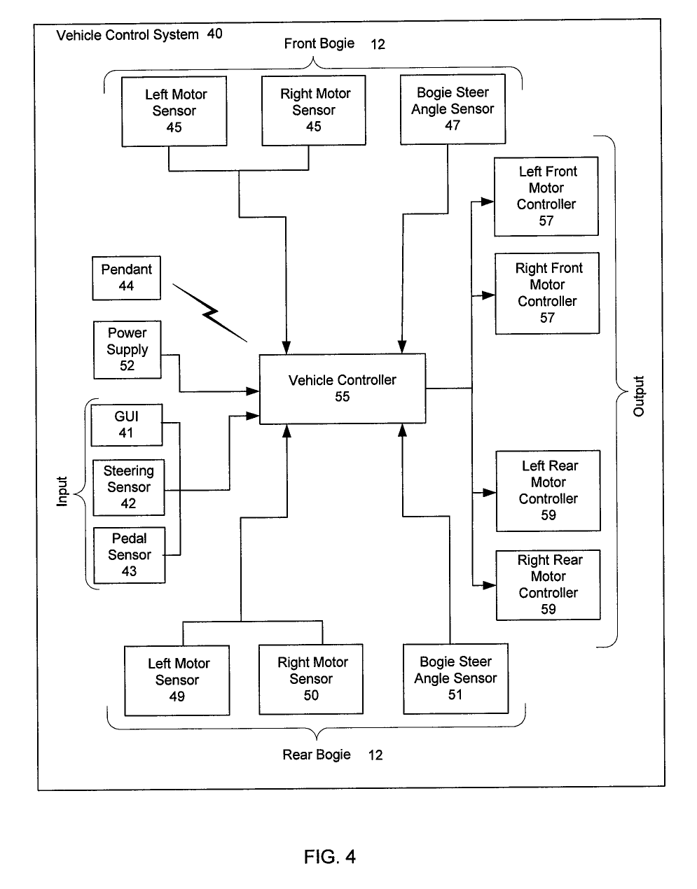

As shown in FIG. 3, each bogie 12 preferably has two wheels 5, but can have any number of suitable wheels 5. Additionally, each vehicle 10 has a front bogie 12 and a rear bogie 12, and so when combined with another vehicle 10, four bogies 12 are possible (i.e., one at each corner). However, it is understood that each vehicle 10 can have any number of suitable bogies 12 for driving and transporting a load. As seen in FIG. 3, each bogie 12 has two motor driven wheels 5 on an axle 32. Each wheel 5 is driven by a separate hydraulic motor 35, but can be driven in any suitable manner. The velocity and steering of the vehicle 10 is controlled by independently controlling the velocity of the motor driven wheels on the left and right side of the bogie 12 (known as differential steering). The details of this steering operation will be described with reference to FIGS. 4-6. By driving and steering the four independent bogies 12, the velocity, the direction of rotation, and heading of the vehicle 10 as a whole can be precisely controlled.

Referring to FIG. 4, one embodiment, a vehicle control system 40 for steering a vehicle 10 is illustrated. By way of example, the vehicle control system (VCS) 40 is implemented in the vehicle 10 illustrated in FIG. 1. However, it should be understood that the VCS 40 can be implemented in other similar vehicles 10. In this embodiment, the VCS 40 is implemented for steering one or more vehicles 10 while ensuring the vehicles 10 operate within prescribed limits; particularly when transporting a load such as a building. Generally, the VCS 40 is provided power from, for example, a 24 VDC power supply 52, which can be provided from the alternator (not shown) of the vehicle 10. The alternator provides power to the VCS 40 when the engine of the vehicle 10 is started. The power supply 52 can also include a 24 VDC uninterruptible power supply or battery for powering the VCS 40 when the primary power is not available.

In FIG. 4, the VCS 40 includes at least one input device 41, 42, 43; sensors 45, 47 coupled to the front bogie 12; sensors 50, 51 coupled to the rear bogie 12; a vehicle processor 55 and motor controllers 57, 59 for controlling the wheels of the front and rear bogies 12. The input devices can include, but are not limited to, a graphical user interface (GUI) 41, steering sensor 42 and pedal sensor 43. The GUI 41 can be a touch screen panel implemented as a man-machine interface that is located in the cab 1 of the vehicle 10. By way of example, the GUI 41 can be an Allen Bradely PanelView Plus™ that is a 15-inch screen with keypad and touch screen capability. However, other types of GUIs 41 sufficient for achieving a man-machine interface are possible. The steering sensor 42 can be, for example, a rotary sensor for sensing a degree of rotation of a steering wheel in the cab 1 of the vehicle 10; and the pedal sensors 43 can include sensors for both the brake pedal and the accelerator pedal. By way of example, the sensor for the brake pedal can be a Hall Effect sensor and the sensor for the accelerator pedal can be a rotary sensor. However, any sensors suitable for sensing rotation or movement can be implemented.

The motor sensors 45 can be rotary encoders coupled to each wheel motor of the front and rear bogies 12 for sensing the rotational speed of the motor. Additionally, the bogie steer angle sensor 47 can be a rotary sensor positioned at each bogie 12 for determining the direction or heading of the bogie 12, which can, in turn, be used to determine the heading or direction of the wheels 5. As seen in FIG. 4, the motor sensors 45 and the bogie steer angle sensors 47 provide input signals to the vehicle controller 55. The vehicle controller 55 also receives the input signals from the operator (e.g., via the input device 41, 42, 43) regarding a desired speed and direction of the vehicle.

By way of example, the vehicle controller 55 can include one or more Allen Bradley ControlLogix 5000™ programmable logic controllers (PLC). The PLC is an automation industry standard controller with a programmable microprocessor, a variable number and types of input/output devices, and a specialized programming language. However, it should be understood that the vehicle controller 55 can also be a proportional-integral controller, a proportional-integral-derivative controller, a fuzzy logic controller, a solid state controller, a logic engine, digital or analog controller or any other suitable combination of discrete electrical components.

In another embodiment, the VCS 40 will use a redundant PLC configuration, which will provide a second PLC to monitor the primary PLC as well as provide a way to initiate an emergency stop and bring the vehicle 10 to a safe state. By way of example, the vehicle controller 55 and its supporting circuitry can be housed inside an protective enclosure (not shown) located on the vehicle 10 along with its power supply and input/output modules. By way of example, the protective enclosure can be located in the cab 1 or any other suitable location on the chassis 4. The vehicle controller 55 includes algorithms used for processing the input signals from the user and the sensors, and providing a command signal to each of the motor controllers 57, 59. The motor controllers 57, 59 act as a local controller coupled to the motor for controlling the operation or rotation of the wheels 5. For example, if the motor is a hydraulic motor, the motor controller 57, 59 would operate a proportional valve thereby varying the hydraulic force and rotational velocity of the motor.

In one embodiment, VCS 40 also includes a wireless hand-held controller (HHC) or pendant 44. An operator can operate several functions of the vehicle 10 from the pendant 44, which can be a light weight, ergonomically designed transmitter with two dual axis joysticks for controlling features for one or more vehicles 10. It is contemplated that the range of the pendant 44 is approximately 330 feet and can communicate with the VCS 40 on any one of 256 channels, which will preclude any cross-talk when the pendant 44 is used to communicate with multiple vehicles 10. Additional features contemplated when using the pendant 44 include the use of unique ID codes for maximum security, watchdog error circuitry, output relay monitoring, frequency deviation deflection indicator, password protection, audible alarm codes and a key used for operating the pendant 44.

Additionally, in one embodiment, the pendant 44 can function in multiple modes, e.g., Load, Set, Extract and Maintenance modes, when enabled by an operator in the cab 1 of one vehicle 10 (e.g., “master vehicle”). From the cab 1, the operator will use the GUI 41 to select a hand-held controller screen. The GUI 41 will display the hand-held controller screen when the vehicle 10 is in a predetermined mode of operation. On this screen, the operator can enable the pendant 44, and an indicator light will illuminate on the pendant 44 to show that it has been enabled. The operator in the cab 1 will then select the function of the vehicle 10 to be operated, which will configure the joystick and/or pushbutton on the pendant 44 to operate the selected function. In one embodiment, once the pendant 44 has been enabled, the vehicle 10 cannot be driven from either a master or a slave drive console.

The pendant 44 also requires a 24 VDC power source, which can be the same power source used to provide power to the VCS 40. The pendant 44 can be used to operate functions of one or more vehicles 10, depending on its mode of operation. For example, the pendant 44 contains all the necessary hardware and software to manipulate the lift systems of one vehicle 10 to determine proper operation. In another mode, the pendant 44 can be used to manipulate the lifts systems of two vehicles 10 simultaneously. If two pendants 44 are enabled, the VCS 40 will disregard both pendants 44 and issue an alarm to the operator. Exemplary functions of the vehicle 10 that can be operated via the pendant 44 are noted below.

Pendant Functions

Engage/Disengage House Attachments To Vehicle

Master Vehicle Front Bogie Raise/Lower.

Master Vehicle Rear Bogie Raise/Lower.

Slave Vehicle Front Bogie Raise/Lower.

Slave Vehicle Rear Bogie Raise/Lower.

Vehicle Chassis Raise/Lower

The pendant 44 can also be used to implement emergency features. For example, the pendant 44 can include an emergency stop pushbutton, which will drop the emergency stop power bus when pressed. A deadman/enable pushbutton on the pendant 44 is included to allow a selected function to proceed after an emergency stop. Releasing this pushbutton will stop all motion in the same manner as the motion stop pushbutton in the cab 1. When the operator in the cab 1 releases the deadman/enable pushbutton all motion will stop and the pendant 44 will be disabled.

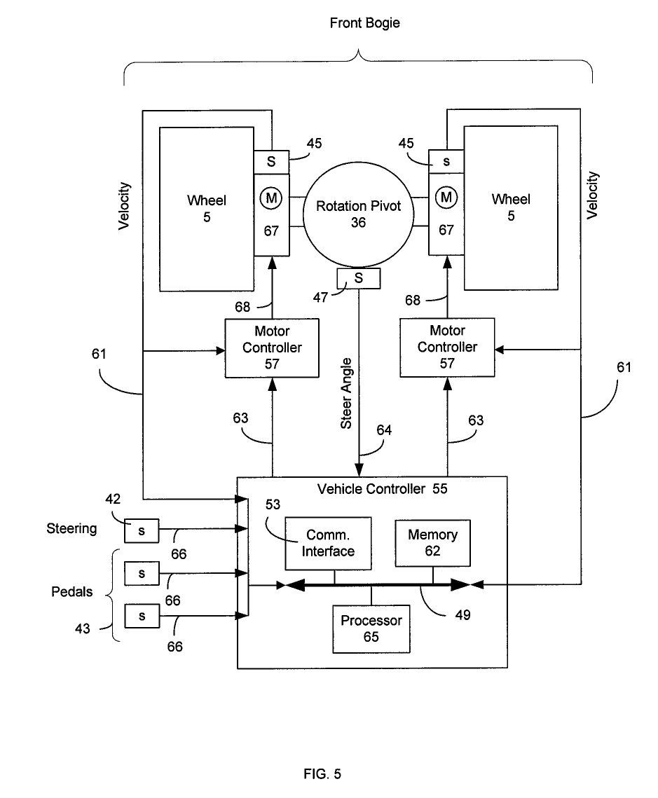

In FIG. 5, in one embodiment, the vehicle control system 40 for steering a vehicle 10 will be described in more detail. In FIG. 5, differential steering of each bogie 12 is achieved by independently controlling the velocity of each wheel 5. By way of example, the steering process begins when an operator of the vehicle 10 provides an input regarding a desired speed and direction. The operator's inputs are sensed by the steering and pedal sensors 42, 43, which provide data signals to the vehicle controller 55 via the network bus 49. The vehicle controller 55 includes at least one processor 65 and a memory 62. The processor can be, for example, an Allen Bradley ControlLogix 5000™ programmable logic controller (PLC). The memory 62 can be a computer-readable media used to store executable instructions or algorithms, which are executed by the processor 65 to perform processing of the data signals. The term “algorithm” as used herein is intended to encompass a computer program that exists permanently or temporarily on any computer-readable medium.

The memory 62 can be ROM, RAM, PROM, EPROM, a smart card, SIMs, WIMs or any other medium from which a processor 65 or other computing device can read executable instructions or algorithms. Additionally, the instructions can be read into memory 62 from another computer-readable medium, such as another storage device. Execution of the instructions contained in memory 62 cause the processor 65 to perform the process steps described herein. One or more processors 65 in a multi-processing arrangement may also be employed to execute the instructions contained in memory 65. In alternative embodiments, hard-wired circuitry may be used in place of or in combination with software instructions to implement the processing steps described herein. Thus, the embodiments described are not limited to any specific combination of hardware circuitry and software.

The processor 65 also receives the actual speed of each wheel 5 as well as the actual steer angle of the bogie 12 via various local sensors 45, 47, which also communicate with the processor 65 via the network bus 49. The speed of each wheel 5 is determined by a sensor 45 coupled directly to the motor 67 that senses the rotational speed of the motor 67 which, in turn, can be used to determine the speed of each wheel 5. The motor sensors 45 can be rotary encoders that provide feedback signals 61 to the vehicle controller 55 regarding the actual rotational speed or velocity of each motor 5. The steer angle of the bogie 12 is determined from a steer angle sensor 47 coupled to the center of the bogie 12. The steer angle sensor 47 can be a rotary encoder that senses a direction or heading of the bogie 12 and provides a feedback signal 64 to the vehicle controller 55. The processor 65 uses data from the input signals 66 and the feedback signals 61, 64 of the sensors 45, 47 to achieve the desired speed and direction of the vehicle 10.

For example, by controlling the speed of one corner of the vehicle 10 at a different rate than another corner of the vehicle 10, the vehicle 10 can be turned in a desired direction and at a desired speed. The processor 65 controls the speed of each wheel 5 of the bogie 12 by outputting a command signal 63 to each corresponding motor controller 57. The motor controller 57 can be a proportional-integral controller, a proportional-integral-derivative controller, a fuzzy logic controller, a solid state controller, a logic engine, digital or analog controller or any other suitable combination of discrete electrical components. The motor controller 57, in turn, outputs a control signal 68 to control the operation of the motors 67. The voltage feedback signal 61 is also received by the motor controller 57 for making refinements to the command signal 63 received from the vehicle controller 55. The direction of the vehicle 10 is controlled by independently controlling the speed of each wheel 5.

The VCS 40 also includes a communication interface 53 coupled to bus 49. The communication interface 53 provides a two-way data communication coupling to a network link. For example, the communication interface 53 may be a digital subscriber line (DSL) card or modem, an integrated services digital network (ISDN) card, a cable modem, a telephone modem, or any other communication interface to provide a data communication connection. As another example, communication interface 53 may be a local area network (LAN) card (e.g. for Ethernet™ or an Asynchronous Transfer Model (ATM) network) to provide a data communication connection to a compatible LAN. Additionally, a wireless link can also be implemented using the communication interface 53.

In any such implementation, communication interface 53 sends and receives electrical, electromagnetic, or optical signals that carry digital data streams representing various types of information. Further, the communication interface 53 can include peripheral interface devices, such as a Universal Serial Bus (USB) interface, a PCMCIA (Personal Computer Memory Card International Association) interface, etc. Although a single communication interface 53 is depicted in FIG. 5, multiple communication interfaces can also be employed. An advantage of using this form of steering control is that it enables more precise and incremental changes to the speed of each wheel 5, resulting in more precise maneuvering.

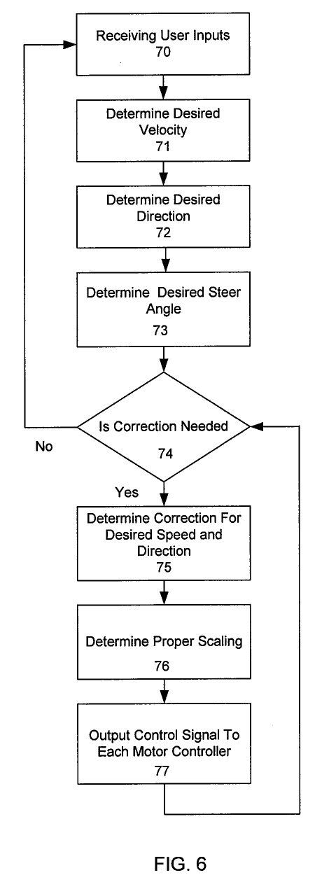

In FIG. 6, one embodiment of the instructions or algorithms for controlling the speed and direction of a vehicle 10 are illustrated. At step 70, the processor 65 receives input signals from an operator via the steering sensor and pedal sensors 43 related to a desired speed and direction of the vehicle 10. The desired speed and direction are expressed as a command velocity and an angular velocity. In step 71, the processor uses an algorithm either stored in the processor 65 itself, or in the memory 62 to calculate a desired velocity vector. The processor 65, in step 72, calculates a unit vector representing a desired direction, and in step 73 a desired steer angle of the bogie 12 is calculated. In step 74, the processor 65 compares the actual speed of each wheel 5 and the direction of each bogie 12 to the desired values, and determines if correction is needed. The actual speed of each wheel 5 and the actual direction of each bogie 12 are provided by the feedback signals 61, 64 from the sensors 45, 47.

If correction is needed, then in step 75, the processor 65 determines the speed for each wheel 5 necessary to achieve the desired speed and direction. The corrected values of the speed of each wheel 5 and the direction of the bogie 12 are then scaled to determine proper spin rates. The processor 65 then sends a corresponding command signal to each motor controller 57, 59. The motor controllers 57, 59, in turn, control the speed of each wheel 5 to achieve the desired speed and direction. After, the initial correction to the speed and direction of the vehicle 10, the processor 65 will continue to determine if further correction is needed, as in step 74. On the other hand, if no correction is needed, then the processor 65 continues to monitor for user inputs regarding a desired speed and direction, as in step 70. A command signal corresponding to the uncorrected desired values can be output (not shown) to each motor controller, or the motor controllers can continue to operate on previously dispatched commands.

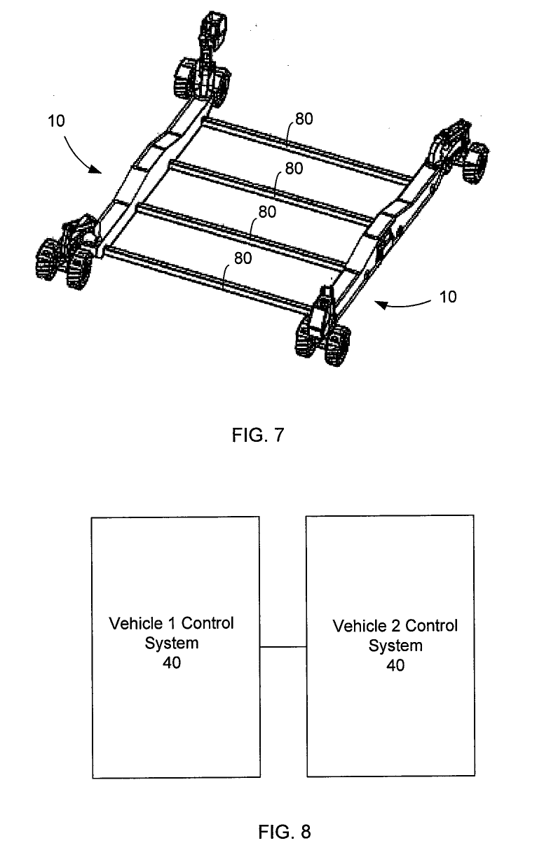

In FIG. 7, in one embodiment, two vehicles 10 connected together are illustrated. Once the two independent vehicles 10 are precisely located, the two vehicles 10 can be connected via the protrusions 15 and the support beams 80. Once in this configuration, a load can be lifted and transported by the vehicles 10. Before the load is loaded, an inter-connect cable between the two vehicles 10 is connected, so that the vehicles 10 can communicate, and operate as one unit in a master/slave arrangement to load and transport the load. The cables can be routed so that raising and lowering of the load will not damage or disconnect the cables. A military or aircraft style connector can be used. In one embodiment, one vehicle 10 is selected as the master and the other is selected as the slave using a selection switch on each of the cab's GUI 41 (FIG. 4). However, it is noted that the vehicles 10 can couple in any suitable manner and do not necessarily need to be electrically coupled in this manner or approach, or even be positioned in this manner. Once connected, the VCS 40 confirms that the two inter-connect cables are attached and that one cab 1 is set as master and one is set as slave. The VCS 40 also confirms that all load sensors (not shown) are within nominal range and that the load is level and/or planar within tolerance as well as other suitable tests as may be required to verify that it is safe to change modes. At this point, the master cab 1 operator can begin moving the vehicle 10.

While driving, two operators (e.g., one in each cab 1), preferably control the vehicle's motion while communicating (e.g., via headsets), However, it is not necessary for the operators to communicate in any particular manner, or communicate at all. The vehicle 10 can operate with any suitable number of operators and/or the operators can be positioned remotely from the vehicle 10 and can communicate using a wired or wireless means (e.g. pendant 44). In one embodiment, the vehicles can be computer controlled. From each of the operators' points of view, each feels as if they are driving their own corner of the vehicle 10 via a steering wheel or joystick on the console (not shown).

As vehicle 10 starts to move, all four bogies 12 can be folded in to their fully retracted position. Such positioning will allow the overall wheel track to be narrow enough to pass through potentially narrow areas; however, the bogies 12 can be positioned in any desired configuration. Folding in this position can be achieved by means of a switch on the console or by any other suitable means. However, the bogies 12 can be positioned in any desired or suitable position at any time during loading, setting or transporting a load.

As seen in FIG. 8, the VCS 40 for each vehicle 10 can be connected. In one embodiment, two inter-connect cables between the two independent vehicles 10 can be connected (e.g., one at the front and one at the back), so that the vehicles 10 can operate as one unit in a master/slave configuration. The overall velocity is governed primarily by the inputs of the master (front) operator. However, both operators must maintain pressure on a deadman enable switch (not shown) to enable motion. In one embodiment, when the two vehicles 10 are connected, the two VCS 40 will communicate via a redundant Ethernet network. Additionally, a watchdog signal will be shared between the two VCS 40 systems to ensure the proper activity of each controller. In one embodiment, the VCS 40 will not allow any motion until the operators select a master or slave configuration.

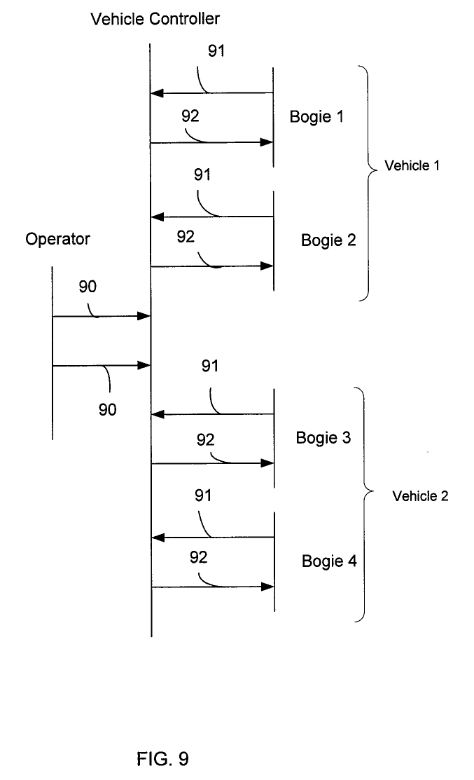

FIG. 9 illustrates, in one embodiment, communication between the VCS 40 for controlling steering and speed of two vehicles 10. In FIG. 9, it is assumed that the two vehicles 10 are connected in a master/slave configuration. As noted above, the operator of the vehicle 10 designated as the master will provide the inputs to the VCS 40 for controlling speed and direction of the vehicle 10. Thus, the operator of the master vehicle provides input signals 90 to the vehicle controller 55. Similar to FIG. 5, the inputs 90 are provided via a steering and pedal sensors 42, 43 located on the master vehicle. The vehicle controller 55 will then determine the desired speed and direction of the vehicle 10 based on the user inputs, and compare the desired value to corresponding actual values. In this case, the actual speed and direction of the two vehicles 10 is determined from sensors 45, 47 located at each individual bogie 12. The sensors 45, 47 provide feedback signals 91 to the vehicle controller 55. Based on comparison, the vehicle controller 55 provides a command signal 92 to each motor controller 57, 59 to control the speed or velocity of each motor driven wheel 5. It is important to note that each wheel 5 of each bogie 12 is independently controlled in this fashion to achieve the desired speed and direction of the vehicle 10.

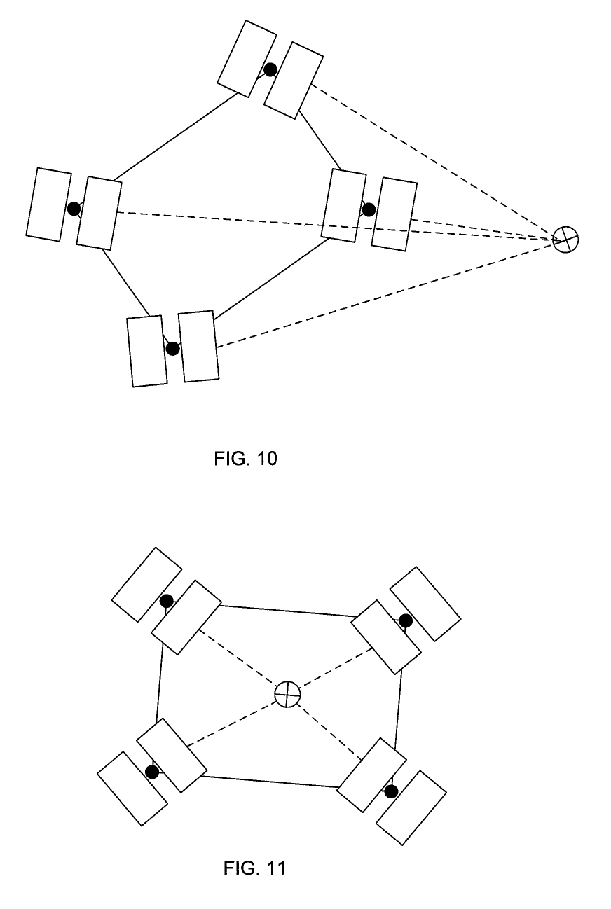

In FIGS. 10 & 11, one embodiment for calculating an instantaneous center of two vehicles 10 connected together is illustrated. The VCS 40 performs the instantaneous center calculation to adjust the direction of the bogies 12 at each corner to minimize stress on the vehicle 10 as well as the stress on the load being transported. The vehicle controller 55 includes algorithms to calculate an “instant center” about which to rotate the vehicle 10. This instant center may be under the vehicle 10 or some distance away, based on the desired movement of the vehicle 10. At each moment, the four bogies 12 are driven to align such that their direction of travel is perpendicular to a radial line drawn from the instant center of the bogie 12. For example, when the vehicle 10 is traveling in a straight line the instant center is an infinite distance from the vehicle 10. As illustrated in FIG. 10, the instant center is to the right of the vehicles 10; and as illustrated in FIG. 11, the instant center is located directly underneath the vehicles 10. When the instant center is located beneath the vehicles 10, the vehicles 10 rotate about that point. When the instant center is located outside the vehicles 10, the path of travel in a circular about that point. As the distance to the instant center increases, the path of travel becomes decreasingly curved until, at infinite distance, the path is straight.

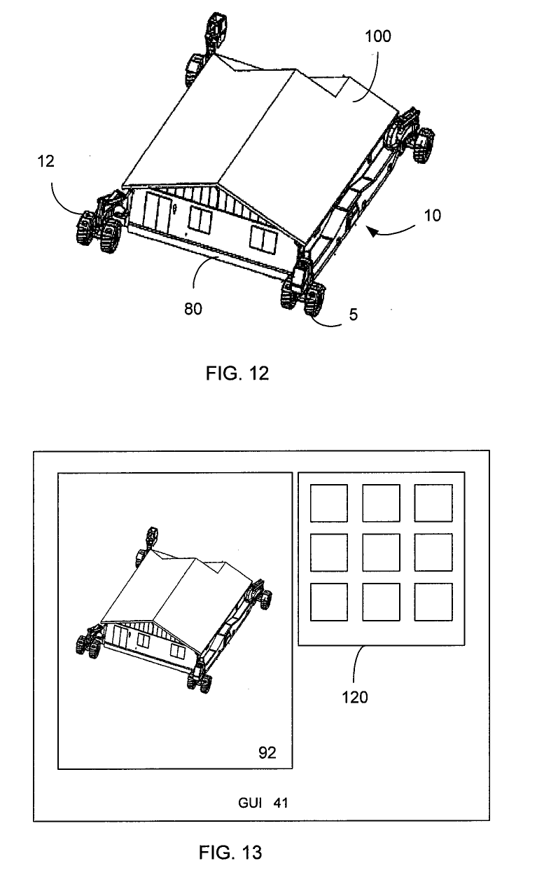

Referring to FIG. 12, one embodiment for transporting a load using two connected vehicles 10 is illustrated. In FIG. 12, the two vehicles 10 are connected using the protrusions 15 (FIG. 1) and the support beams 80. Preferably there are a plurality of support beams 80 traversing the two vehicles 10 for sufficiently supporting the load. In this case, the load being transported is a building 100 that is secured between the two vehicles 10. Once secured, the building 100 can be easily transported and maneuvered by independently controlling the speed and direction of each wheel 5 of the bogies 12 using the VCS 40, as described previously.

FIG. 13, in one embodiment, illustrates a GUI 41 (FIG. 4) that can be implemented in any one of the cabs 1 of the two vehicles 10. As seen in FIG. 4, the GUI 41 can be used to assist the operator in transporting a load by providing a graphical display 92 that illustrates the two vehicles 10 and the load being transported. The GUI 41 is particularly useful during the final maneuvering of the load, when certain areas of the load and the vehicles 10 may be difficult to see. By way of example, the load being transported in FIG. 12 is a building 100. Cameras (not shown) located a different positions around the vehicle 10 can assist the operator in seeing areas not visible from the cab 1. The GUI 41 can be used to select a particular camera view. The operator can also use the touch screen 120 on the GUI 41 for interface with the VCS 40.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A control system for steering at least one vehicle, comprising:
a first plurality of sensors, each sensor being operably coupled to a respective wheel of the vehicle;
a second plurality of sensors, each sensor being operably coupled to a respective input device; and
a vehicle controller operably coupled to the sensors and to each respective wheel, the vehicle controller being configured to control the velocity of each wheel to achieve a desired speed and direction of the vehicle based on a plurality of data signals received from the sensors.

2. The system of claim 1, wherein the input device is configured for inputting a desired speed and direction of the vehicle.

3. The system of claim 1, wherein the first plurality of sensors includes at least one sensor for sensing a velocity of each respective wheel, and at least one sensor for sensing a direction of each respective wheel.

4. The system of claim 1, wherein the second plurality of sensors includes at least one sensor for sensing a desired direction of the vehicle, and at least one sensor for sensing a desired velocity of the vehicle.

5. The system of claim 1, further comprising at least one motor and corresponding motor controller operably coupled to each respective wheel for controlling the wheel velocity.

6. The system of claim 1, wherein the vehicle controller further comprising:
a memory device; and
a plurality of instructions stored on the memory device, the instructions when executed by at least one processor, cause the vehicle controller to:
determine a desired speed and direction of the vehicle based on at least one data signal received from the second plurality of sensors;
determine an actual speed and direction of the vehicle based on at least one data signal received from the first plurality of sensors;
compare the desired speed and direction of the vehicle with an actual speed and direction of the vehicle; and
control the velocity of each respective wheel to achieve the desired speed and direction based on said comparison.

7. A vehicle including a steering control system, the vehicle comprising:
a plurality of input devices for inputting a desired speed and direction of the vehicle;
a first plurality of sensors, each sensor being operably coupled to a respective wheel of the vehicle;
a second plurality of sensors, each sensor being operably coupled to a respective input device; and
a vehicle controller operably coupled to the input device, the sensors and each respective wheel, the vehicle controller being configured to control the velocity of each respective wheel to achieve a desired speed and direction based on a plurality of data signals received from the sensors.

8. The vehicle of claim 7, wherein the first plurality of sensors includes at least one sensor configured to sense the velocity of each respective wheel and at least one sensor configured to sense the direction of each respective wheel.

9. The vehicle of claim 7, wherein the second plurality of sensors includes at least one sensor for sensing a desired direction of the vehicle and at least one sensor for sensing a desired velocity of the vehicle.

10. The vehicle of claim 7, wherein the vehicle controller further comprising:
a memory device; and
a plurality of instructions stored on the memory device, said instructions when executed by at least one processor, cause the vehicle controller to:
determine a desired speed and direction of the vehicle based on at least one data signal from the second plurality of sensors;
determine an actual speed and direction of the vehicle based on at least one data signal received from the first plurality of sensors;
compare the desired speed and direction of the vehicle with the actual speed and direction of the vehicle; and
control the velocity of each respective wheel based on said comparison.

11. The vehicle of claim 7, further comprising at least one motor with a corresponding motor controller operably coupled to each wheel.

12. The vehicle of claim 11, wherein at least one of the motors is a hydraulic motor.

13. The vehicle of claim 7, further comprises a graphical user interface to assist a an operator in steering the vehicle.

14. The vehicle of claim 7, wherein the input devices includes at least a steering wheel and an accelerator pedal.

15. A method of steering at least one vehicle, comprising:
receiving at least one input regarding a desired speed and a direction of the vehicle;
determining a desired speed and direction of the vehicle based on the input;
determining an actual speed and direction of the vehicle from a sensed velocity and speed of each respective wheel of the vehicle; and
comparing the desired speed and direction of the vehicle with the actual speed and direction of the vehicle;
controlling the velocity of each respective wheel based on said comparison,
wherein the velocity of each respective wheel is controlled to achieve the desired speed and direction of the vehicle.

16. The method of claim 15, further comprising controlling the velocity of each respective wheel independently.

17. The method of claim 15, further comprising controlling one wheel at a first velocity and another wheel at a second velocity for achieving a desired direction.

18. The method of claim 15, further comprising connecting at least two vehicles in a master/slave configuration to control speed and direction of both vehicles.

19. The method of claim 18, further comprising determining an instantaneous center of gravity of the vehicles.

20. The method of claim 15, further comprising outputting a command signal to a corresponding motor controller for controlling the velocity of each respective wheel of the vehicle.
